(19) United States
(12) Patent Application Publication
(10) Pub. No.: US 2022/0307850 A1
(43) Pub. Date: Sep. 29, 2022

(54) OPTIMUM PATH SELECTION APPARATUS AT PREDETERMINED PREMISES, METHOD, AND PROGRAM

(71) Applicant: NEC Corporation, Minato-ku, Tokyo (JP)

(72) Inventor: Yosuke IZUMIKAWA, Tokyo (JP)

(73) Assignee: NEC Corporation, Minato-ku, Tokyo (JP)

(21) Appl. No.: 17/615,889

(22) PCT Filed: Jun. 3, 2020
(86) PCT No.: PCT/JP2020/021891

§ 371 Date: Dec. 2, 2021

(30) Foreign Application Priority Data
Jun. 4, 2019 (JP) 2019-104469

(51) Int. Cl. G01C 21/34; G06Q 30/06; H04W 4/33; H04W 4/35

(52) U.S. Cl. CPC G01C 21/3476; G06Q 30/0639; H04W 4/33; H04W 4/35

(57) ABSTRACT

While path search at station premises, etc. has been performed without considering to stop by a store, etc. on the way to the destination, improvement on this path search is demanded. An optimum path selection apparatus at premises, includes: a user entry detection part that receives identification information transmitted from a terminal(s) held by a user(s) and detects entry of the user(s) into predetermined premises; a user information acquisition part that acquires, from the terminal(s), information about a destination(s) of the user(s), information about use or non-use of a facility(ies) on the premises, and information about a product(s) desired to be purchased at a store(s) on the premises; a path acquisition part that acquires an optimum path(s) to the destination(s) via the store(s) on the premises having the product(s) in stock; and an information presentation part that transmits the optimum path(s) to the terminal(s) held by the user(s).

### TECHNICAL FIELD

### Reference to Related Application

The present invention is based upon and claims the benefit of the priority of Japanese patent application No. 2019-104469, filed on Jun. 4, 2019, the disclosure of which is incorporated herein in its entirety by reference thereto.

The present invention relates to an optimum path selection apparatus, a method, and a program that enable, when there are products purchasable at stores of predetermined premises, to purchase the products on a path from a location at the predetermined premises to a destination.

### BACKGROUND ART

An optimum path (route) search apparatus can be used not only outdoors but also at certain facilities such as station premises, and so on, and provides passengers visiting huge stations with information about paths to reach their destination platforms.

There has been proposed a system for searching for a path along which passengers can move to the boarding location of a train car in view of the congestion situations of the train cars and the use of an elevator or an escalator at station premises (see Patent Literature (PTL) 1, for example).

### CITATION LIST

### Patent Literature

PTL 1: Japanese Patent Kokai Publication No. 2006-244069

### SUMMARY

### Technical Problem

Please note that disclosure of the above PTL 1 is incorporated herein by reference thereto. The following analysis has been made by the present inventor.

In the technique described in the above PTL 1, a case where a user stops by a store, such as a convenience store, or the like, on the way to the boarding location of a train car is not considered. In addition, since many convenience stores at station premises have small in-store space, it is difficult for users on wheelchairs and users having a disability in their legs (who will be referred to as “users in need of assistance”) to use these convenience stores.

Furthermore, there are also stores, such as “KIOSKs”, which have their products displayed outside. However, since these stores have a small number of products in stock, there are cases where users cannot purchase their desired products. In addition, when products that users wish to purchase are stacked on upper shelves, the users cannot reach these products. In these cases, the users may experience inconvenience.

It is an object of the present invention to provide an optimum path selection apparatus, a method, and a program that contribute to providing, when a user including a user in need of assistance wishes to purchase a product(s) at a predetermined location(s) or premises such as station premises, information or the like about an optimum path to reach the destination in addition to purchasing the product(s).

### Solution to Problem

According to an optimum path selection apparatus at premises of a first aspect of the present invention, it is provided an optimum path selection apparatus at premises, including: a user entry detection part that receives identification information transmitted from a terminal(s) held by a user(s) and detects entry of the user(s) into predetermined premises; a user information acquisition part that acquires, from the terminal(s), information about a destination(s) of the user(s), information about use or non-use of a facility(ies) on the premises, and information about a product(s) desired to be purchased at a store(s) on the premises; a path acquisition part that acquires an optimum path(s) to the destination(s) via the store(s) on the premises having the product(s) in stock; and an information presentation part that transmits the optimum path(s) to the terminal(s) held by the user(s).

According to an optimum path selection method of a second aspect of the present invention, it is provided an optimum path selection method, including: a user entry detection step of receiving identification information transmitted from a terminal(s) held by a user(s) and detecting entry of the user(s) into predetermined premises;

a user information acquisition step of acquiring, from the terminal(s), information about a destination(s) of the user(s), information about use or non-use of a facility(ies) on the premises, and information about a product(s) desired to be purchased at a store(s) on the premises; a path acquisition step of acquiring an optimum path(s) to the destination(s) via the store(s) on the premises having the product(s) in stock; and an information presentation step of transmitting the optimum path(s) to the terminal(s) held by the user(s).

According to an optimum path selection program of a third aspect of the present invention, it is provided an optimum path selection program, causing a computer to perform processings of: receiving identification information transmitted from a terminal(s) held by a user(s) and detecting entry of the user(s) into predetermined premises; acquiring, from the terminal(s), information about a destination(s) of the user(s), information about use or non-use of a facility(ies) on the premises, and information about a product(s) desired to be purchased at a store(s) on the premises; acquiring an optimum path(s) to the destination(s) via the store(s) on the premises having the product(s) in stock; and transmitting the optimum path(s) to the terminal(s) held by the user(s).

### Advantageous Effects of Invention

According to the present invention, when a user in need of assistance shows his or her interest in purchasing a product(s) at predetermined premises such as station premises, guide of a path to his or her destination can be realized while taking presentation of information about a candidate product(s) to be purchased and a product reception location(s) into consideration.

### BRIEF DESCRIPTION OF DRAWINGS

FIG. 1 is a diagram illustrating an outline of an example embodiment.

FIG. 2 is a block diagram illustrating an example of a hardware configuration of an optimum path selection server of an optimum path selection apparatus, which is applicable to an individual example embodiment.

FIG. 3 is a block diagram illustrating an example of a hardware configuration of a terminal of the optimum path selection apparatus, which is applicable to an individual example embodiment.

FIG. 4 is a sequence diagram illustrating an operation according to an example of the present invention, which illustrates the operation in a case where there is no product that a user wishes to purchase at stores.

FIG. 5 is a sequence diagram illustrating an operation according to an example of the present invention, which illustrates the operation in a case where there is at least one product that a user wishes to purchase at a store(s).

FIG. 6 illustrates an example of a display on a terminal according to an example of the present invention, which is a diagram of a user interface used when a user is asked about path-related information.

FIG. 7 illustrates another example of a display on the terminal according to an example of the present invention, which is a diagram of a user interface used when a list of products purchasable at premises is presented to a user.

FIG. 8 is a diagram illustrating an example of a user interface of the terminal according to an example of the present invention, the user interface being used when display of a path and an estimated time of reception are presented to a user.

FIG. 9 is a diagram illustrating an outline of a mode including a store information aggregation part 300, store terminals 400, deliverer terminals 410, and a digital signage 110.

### DESCRIPTION OF EMBODIMENTS

First, an outline of an example embodiment will be described. Please note that in the following outline, the reference signs of the drawings are denoted to each element as examples for the sake of convenience to facilitate understanding and are not intended to limit the present invention to the illustrated modes. An individual signal line in the block diagrams in each drawing, to which the description of the example embodiments refers, includes two-way directions in principle and an one-way arrow is not limited to one-way direction. While not illustrated, an input-output interface or port exists at an input-output end of an individual block.

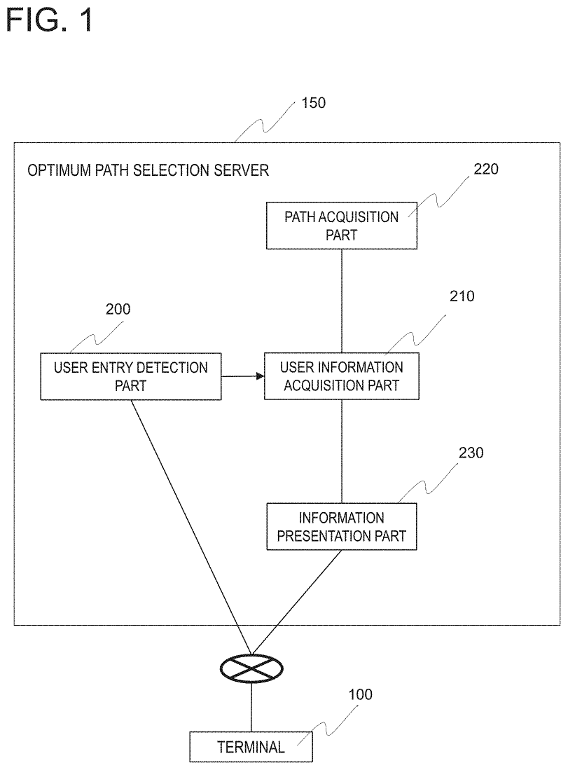

An optimum path selection apparatus according to an example embodiment includes a plurality of terminals 100 and an optimum path selection server 150 that provides at least one of the plurality of terminals 100 with information (see FIG. 1). In addition, the optimum path selection server 150 includes a user entry detection part 200, a user information acquisition part 210, a path acquisition part 220, and an information presentation part 230. The user entry detection part 200 constantly transmits a signal for detecting a user and stores a user ID included in a response from a terminal 100. The user information acquisition part 210 stores the current location and the destination of a user, path-related information such as use or non-use of an escalator(s) or an elevator(s) and so on, a list of products desired to be purchased at a store(s) on the premises, and an optimum path acquired from the path acquisition part 220. The path acquisition part 220 acquires the current location and the destination of the user, the path-related information, and the list of products desired to be purchased at a store(s) on the premises, from the user information acquisition part 210, and selects an optimum path for the user. The information presentation part 230 transmits the list of products desired to be purchased and the optimum path acquired from the user information acquisition part 210 to the terminal 100 held by the user, and provides the destination of a user and a list of products determined to be purchased received from the terminal 100, to the user information acquisition part 210. When a product purchase request from a user is issued by the optimum path selection apparatus, retailers that manage product information and store information and an existing search engine coordinate with each other, and an optimum path in view of delivery of a product(s) is presented to the user.

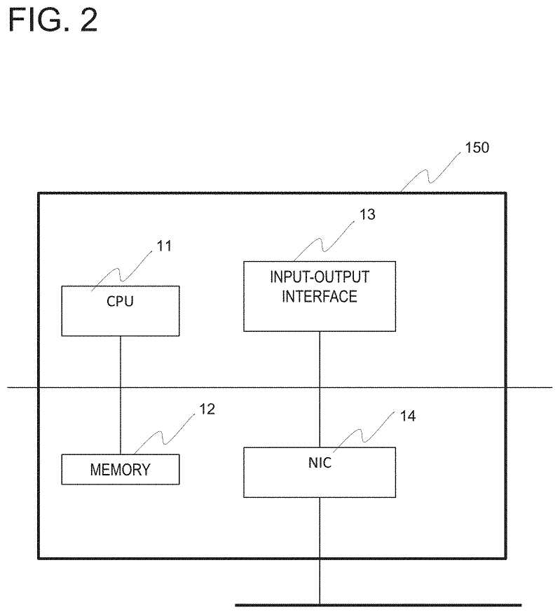

FIG. 2 is a block diagram illustrating an example of a hardware configuration of the optimum path selection server of the optimum path selection apparatus. The optimum path selection server 150 can be configured by a so-called computer (an information processing apparatus) and has a configuration illustrated by an example in FIG. 2.

For example, the optimum path selection server includes a CPU (Central Processing Unit) 11, a memory 12, an input-output interface 13, an NIC (Network Interface Card) 14 serving as a communication interface, etc., which are connected to each other via an internal bus. A user entry detection signal is entered from a detection system, which is not illustrated, via the input-output interface 13 or the NIC 14.

Please note that the configuration illustrated in FIG. 2 is not intended to limit the hardware configuration of the optimum path selection server 150. The optimum path selection server may include hardware not illustrated or may not be provided with the input-output interface 13, as needed. For example, when an operation terminal connected to a network inputs or outputs information from or to the optimum path selection server 150, the input-output interface 13 may be unnecessary. In addition, for example, the number of CPUs 11 or the like included in the optimum path selection server 150 is not intended to limit to the example illustrated in FIG. 2. For example, a plurality of CPUs may be included in the optimum path selection server 150.

The memory 12 is an auxiliary storage device such as a RAM (Random Access Memory), a ROM (Read Only Memory), a hard disk, or the like.

The input-output interface 13 is an interface for a display apparatus or an input apparatus not illustrated. The display apparatus is, for example, a liquid crystal display, and so on. The input apparatus is, for example, an apparatus that receives user operations, such as a keyboard or a mouse, or the like, or an apparatus that receives information from an external storage apparatus such as a USB (Universal Serial Bus) memory, and so on.

Functions of the optimum path selection server 150 are realized by the processing modules to be described below. For example, the processing modules are realized by executing a program stored in a memory by the CPU 11. Furthermore, the program can be updated by downloading a program via a network or by using a storage medium on which a program is recorded. Alternatively, the processing modules as describe above may be realized by semiconductor chips. That is, the functions performed by the processing modules as describe above may be realized by at least hardware or software of some kind.

Furthermore, a computer may be functioned as the optimum path selection server by installing the above computer program in a storage part of the computer. In addition, an optimum path selection method may be performed by a computer by causing the computer to execute the above computer program.

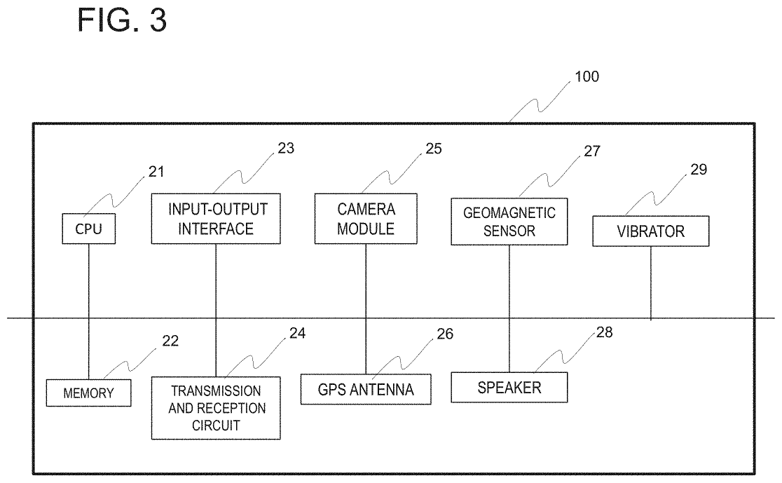

FIG. 3 is a block diagram illustrating an example of a hardware configuration of a terminal of the optimum path selection apparatus. With reference to FIG. 3, the terminal 100 includes a camera module 25, a GPS (Global Positioning System) antenna 26, a geomagnetic sensor 27, a speaker 28, and a vibrator 29, in addition to the above CPU 21, etc. The terminal 100 also includes a transmission and reception circuit that transmits and receives radio signals.

The camera module 25 includes lenses and an image sensor such as a CCD (Charge Coupled Device).

The GPS antenna 26 is used for measuring the location of the terminal 100 and receives GPS signals.

The geomagnetic sensor 27 is a sensor for detecting the direction in which the terminal faces. The terminal 100 may include an angular velocity sensor in place of the geomagnetic sensor. That is, any sensor that can detect the direction of the terminal 100 may be used.

The speaker 28 is a device for emitting sound from the terminal 100. Furthermore, the vibrator 29 is a device for vibrating the terminal 100.

FIG. 1 is a block diagram illustrating an example of a configuration of the optimum path selection apparatus according to an example embodiment. With reference to FIG. 1, the optimum path selection apparatus includes: a user entry detection part that receives identification information transmitted from a terminal(s) held by a user(s) and detects entry of the user(s) into predetermined premises; a user information acquisition part that acquires, from the terminal(s), information about a destination(s) of the user(s), information about use or non-use of a premises facility(ies), and information about a product(s) desired to be purchased at a store(s) on the premises; a path acquisition part that acquires an optimum path(s) to the destination(s) via a store(s) on the premises having the product(s) in stock; and an information presentation part that transmits the optimum path(s) to the terminal(s) held by the user(s) or shapes information received from the terminal(s) and transfers the shaped information to the user information acquisition part.

### Example Embodiment 1

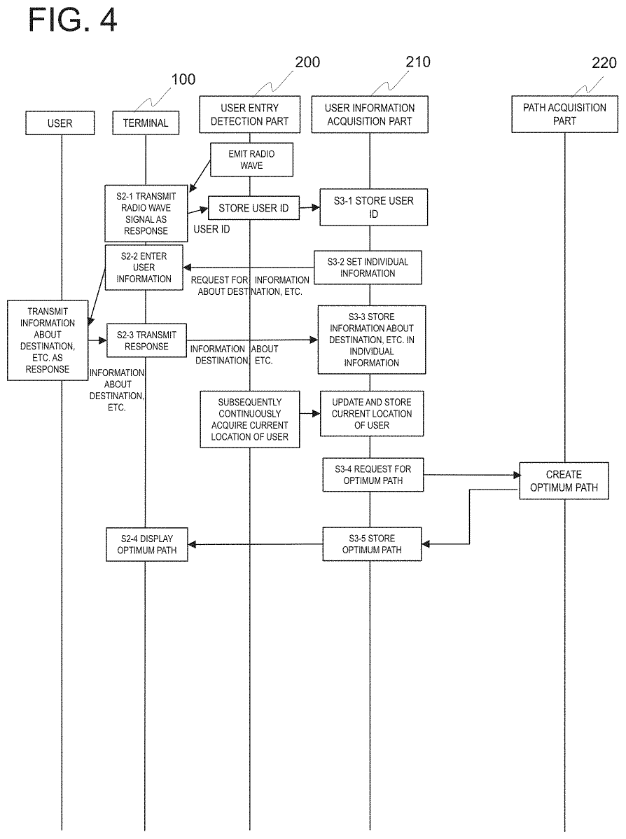

FIG. 4 is a sequence diagram illustrating an operation according to an example of the present invention and shows the operation in a case where there are no products desired to be purchased at stores by a user. In FIG. 4, illustration of the information presentation part 230 is omitted, and information is displayed on the terminal 100.

### Step 1:

When a user enters premises such as a station and so on, by receiving a signal from the user entry detection part 200 installed at the premises, the terminal 100 detects that it has entered the premises. The terminal 100 which has detected that it has entered the premises responds to the user entry detection part 200 by transmitting its own user ID (S2-1). The user entry detection part 200 stores the user ID which is a response to the signal (S3-1).

### Step 2:

The user entry detection part 200 notifies the user information acquisition part 210 of the ID of the user whose entry has been detected. While the user is staying at the premises, the user entry detection part 200 continuously acquires the current location of the user and stores the acquired current location in the user information acquisition part 210. The user information acquisition part 210 requests the terminal 100 held by the user for user information via the information presentation part 230 (S3-2, S2-2).

The user information includes the destination of the user, path-related information about use or non-use of an escalator(s) or an elevator(s) and so on, and a list of products desired to be purchased at a store(s) on the premises.

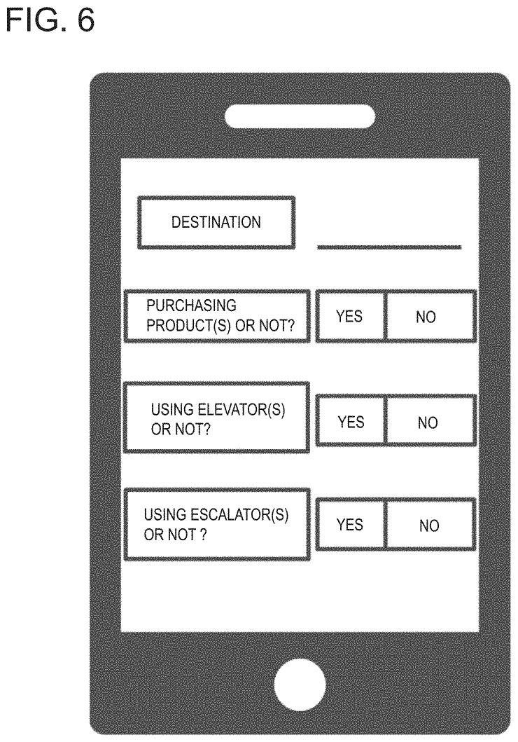

FIG. 6 illustrates a UI image of the terminal 100 in step 2.

### Step 3:

The terminal 100 which has received a request for acquisition of user information responds the user information to the user information acquisition part 210 via the information presentation part 230 (S2-3). If there are no products desired to be purchased, an empty list is set to the list of products desired to be purchased.

### Step 4:

The user information acquisition part 210 requests an optimum path to the path acquisition part 220 by designating the current location and the destination of the user and the path-related information (S3-4). The path acquisition part 220 selects an optimum path from the given conditions and transmits the result to the user information acquisition part 210 as a response.

### Step 5:

The user information acquisition part 210 stores the obtained optimum path (S3-5) and causes the terminal 100 held by the user to display the optimum path via the information presentation part 230 (S2-4).

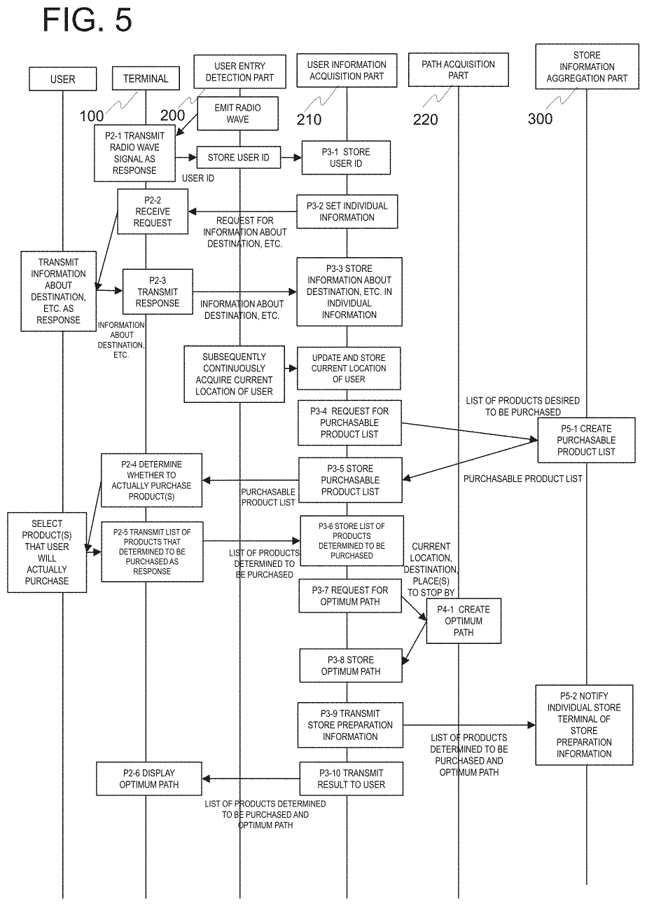

FIG. 5 is a sequence diagram illustrating an operation according to an example of the present invention and shows the operation in a case where there is at least one product desired to be purchased at a store(s) by the user.

In FIG. 5, illustration of the information presentation part 230 is omitted, and information is displayed on the terminal 100.

### Step 1:

When a user enters premises such as a station and so on, by receiving a signal from the user entry detection part 200 installed at the premises by the terminal 100, the terminal 100 detects entry into the premises. The terminal 100 which has detected the entry into the premises responds to the user entry detection part 200 by transmitting its own user ID thereto (P2-1). The user entry detection part 200 stores the user ID responded to the signal (P3-1).

### Step 2:

The user entry detection part 200 notifies the user information acquisition part 210 of the ID of the user who has entered the premises. While the user is at the premises, the user entry detection part 200 continuously acquires the current location of the user and stores the acquired current location in the user information acquisition part 210. The user information acquisition part 210 requests the terminal 100 held by the user for user information via the information presentation part 230 (P3-2, P2-2).

The user information includes the destination of the user, path-related information about use or non-use of an escalator(s) or an elevator(s) and so on, and a list of products desired to be purchased at a store(s) on the premises.

FIG. 6 illustrates a UI image of the terminal 100 in step 2.

### Step 3:

The terminal 100 which has received the request for acquisition of user information transmits the user information to the user information acquisition part 210 via the information presentation part 230 (P2-3).

### Step 4:

If the list of products desired to be purchased being included in the user information, is not empty, the user information acquisition part 210 transmits the list of products desired to be purchased to a store information aggregation part 300 and requests for a purchasable product list to which store information about a store(s) at which respective products can be purchased is added (P3-4).

The store information aggregation part 300 creates a purchasable product list indicating which products are purchasable at what stores and transmits the created purchasable product list to the user information acquisition part 210 as a response (P5-1). The user information acquisition part 210 stores the purchasable product list (P3-5).

If a product is not purchasable due to out of stock or the like, this product is excluded from the purchasable product list.

The store information includes the working rates of the employees, the congestion situations, the past data, etc.

### Step 5:

The user information acquisition part 210 transmits the received purchasable product list to the terminal 100 via the information presentation part 230 and requests the user to determine whether to actually purchase the individual product (P2-4). The terminal 100 displays the purchasable product list on its screen.

### Step 6:

The user selects the product(s) by determining whether to actually purchase the product(s).

The terminal 100 transmits the list of products that the user has actually selected to the user information acquisition part 210 via the information presentation part 230 as a list of products determined to be purchased (P2-5).

The user information acquisition part 210 stores this list of products t determined to be purchased (P3-6).

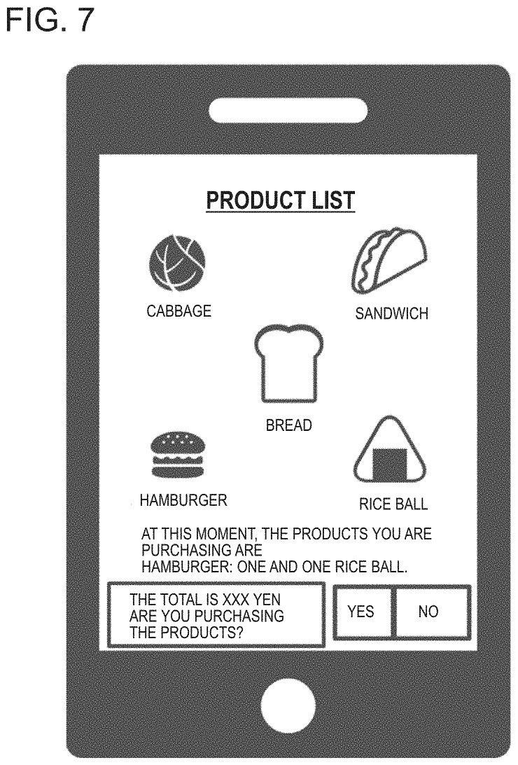

FIG. 7 illustrates an image of the purchasable product list displayed on the terminal 100.

### Step 7:

The user information acquisition part 210 transmits the current location of the user, the destination of the user, and the store(s) needed to stop by, which have been extracted from the list of products determined to be purchased, to the path acquisition part 220 and requests for acquisition of an optimum path (P3-7).

### Step 8:

The path acquisition part 220 acquires an optimum path for the user (P4-1) and transmits, as a response, the acquired optimum path to the user information acquisition part 210. The user information acquisition part 210 stores the optimum path therein (P3-8).

This optimum path selection result includes information about an estimated time of arrival at an individual store.

### Step 9:

The user information acquisition part 210 transmits the list of products determined to be purchased which has been acquired in step 6, and the optimum path selection result to the store information aggregation part 300 (P3-9).

The store information aggregation part 300 transmits the list of products determined to be purchased to a store terminal(s) 400 at each store described in the list of products determined to be purchased (P5-2). An employee(s) or a delivery staff member(s) at each store acquires necessary information from a store terminal(s) 400 at each of the store(s) and makes necessary preparations in which, for example, the employee(s) or the delivery staff member(s) has the product(s) to be purchased by the user ready to be handed to the user by the time the user arrives at the store(s).

### Step 10:

The user information acquisition part 210 transmits the user ID, electronic payment information (Suica ID, for example) held thereby, and the amount of payment calculated based on the list of products determined to be purchased to a payment processing part and requests the payment processing part to perform payment processing.

The payment processing part performs the payment processing.

### Step 11:

The user information acquisition part 210 causes the terminal 100 to display the optimum path selection result and the list of products determined to be purchased via the information presentation part 230 (P3-10).

While the terminal 100 is performing path guide based on the path information received thereby, the terminal 100 displays the individual estimated reception time and the store location(s) in addition to the path guide information already displayed (P2-6).

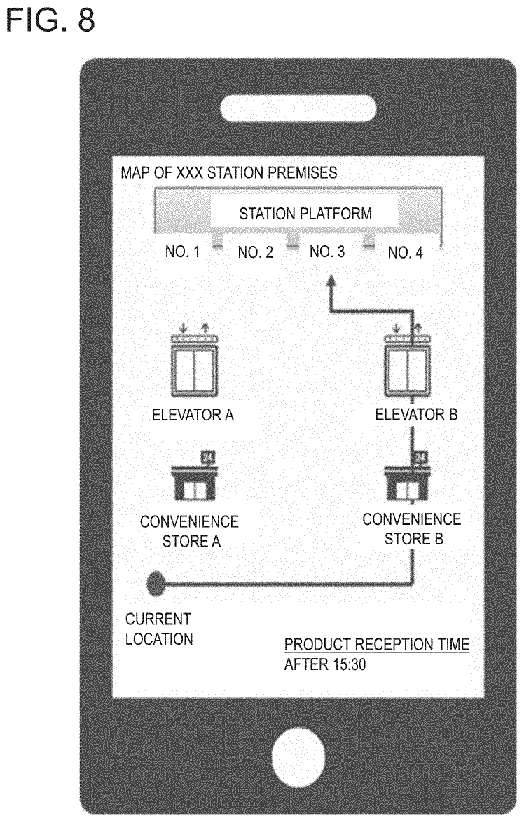

FIG. 8 illustrates an image including path information and an estimated reception time displayed on the terminal 100.

The purchasable product information displayed in step 2 is product information that indicates the product(s) that the store information aggregation part 300 has determined that the store(s) carries in stock and in addition, that has been preliminarily narrowed down to limited product information based on information about the payable amount of money held by a payment function of the terminal.

### Example Embodiment 2

In example embodiment 1, the user information acquisition part 210 notifies the terminal 100 of “the generated shortest path, the store(s) from which the product(s) is(are) to be received, the store location(s), and the estimated reception time” in (P2-6).

In addition to these items of information, when the product(s) becomes ready to be handed over to the user at each store, each terminal of the individual store(s) may notify the terminal 100 of information about completion of the preparation via the user information acquisition part 210.

In this case, the terminal 100 may display notification information indicating “prepared” on the path display displayed based on the acquired “generated shortest path, store(s) from which the product(s) is(are) to be received, and store location(s)”.

In this way, since the user moving on the path can grasp that the product(s) has been prepared, the user can move more quickly.

### Example Embodiment 3

In example embodiment 1, the payment is made in step 10 before the user checks the estimated reception time.

After this payment processing may be temporarily stopped and the user checks the estimated reception time obtained in step 11, the user may notify the user information acquisition part 210 of notification indicating permission of the payment and the payment processing may be performed after checking the notification.

### Example Embodiment 4

In example embodiment 1, the user needs to stop by the individual store(s) to receive the product(s).

By modifying the step 11 and the subsequent steps according to the example embodiment 1 as follows, the individual store(s) can dispatch a delivery staff member(s), and the delivery staff member(s) can meet the user on the way and hand the product(s) to the user.

### Step 11:

A deliverer terminal(s) 410 previously acquires, from a store terminal(s) 400 of the corresponding store(s), the optimum path selection result, the list of products determined to be purchased, and information about the time at which the user can receive the individual product if the user is traveling on the optimum path.

The individual deliverer delivers a product(s) while carrying the deliverer terminal.

This deliverer terminal 410 can acquire information about the current location of the target user from the target user information acquisition part 210 and display the information.

### Step 12:

The user information acquisition part 210 displays the optimum path selection result, the list of products determined to be purchased, and information about at which location on the path the user can receive the individual product(s) on the terminal 100 via the information presentation part 230.

### Step 13:

By using the deliverer terminal(s) 410 held by the deliverer(s), based on the terminal location of the target user and the path information, the deliverer(s) meets the user and hands over the product(s) desired to be purchased.

The payment may be made at the time in step 12 as normal or via the deliverer terminal(s) 410.

### Example Embodiment 5

In example embodiment 1, it is unclear for the user to know how much more time it will take to meet the deliverer(s) from the store(s). This problem is solved by acquiring the current location(s) of the deliverer(s) and the current location of the user at certain time intervals the user information acquisition part and causing the user information acquisition part to display the acquired information on the terminal 100 of the user via the information presentation part 230.

### Example Embodiment 6

In example embodiment 1, only the terminal 100 held by the user is used as the interface with the user.

By modifying step 5 according to example embodiment 1 as follows, the purchasable product(s) can be displayed on a digital signage closest to the current location of the user, instead of the terminal 100.

### Step 5:

The user information acquisition part 210 searches for a digital signage 110 closest to the user by using the current location of the user.

The user information acquisition part 210 causes the digital signage 110 to display the purchasable product list via the information presentation part 230 and requests the user to determine whether the user will actually purchase these products (P2-4). The digital signage 110 displays the purchasable product list on its screen.

### Example Embodiment 7

In example embodiment 1, the user moves in a single building. By modifying example embodiment 1 as follows, when the user moves in a plurality of buildings, the user can receive a product(s) in a building different from the building in which the user is currently located.

In step 2, before causing the terminal 100 to display the purchasable product list the destination of the user is acquired.

If the destination of the user is in a building different from the building in which the user is currently located, the user is requested to select a building where the user wishes to receive a product(s).

Next, a list of products purchasable in the building selected by the user is presented to the user, and the user is requested to select a product that the user wishes to purchase.

### Example Embodiment 8

In example embodiment 1, there are cases where the user wishes to stop by a facility, such as a restroom or an exhibition space, and so on, for an indeterminate length of time and for a relatively long time, and in these cases, it is difficult to accurately determine what time the user will receive the purchased product(s).

By modifying example embodiment 1 such that suspension/resumption processing on the movement on the path can be performed as follows, even when the user stops by the above facility, it is possible to accurately determine estimated time when the user will stop by a normal facility(ies) thereafter.

If a facility that the user will stop by includes a facility at which the user will stay for an indeterminate length of time and for a relatively long time, the time for which the user stays at the facility is temporarily set to 0, and the estimated time at which the user will stop by the subsequent normal facility(ies) is set as the temporarily estimated time. When the user enters the facility, the user presses a movement suspension button displayed on the terminal 100 held by the user. At this time, the terminal 100 notifies, via the information presentation part 230, the user information acquisition part 210 that the user is not currently moving.

When the user exits the facility, the user presses a movement resumption button displayed on the terminal 100 held by the user. At this time, the terminal 100 notifies, via the information presentation part 230, the user information acquisition part 210 that the user has started to move again. Next, the time for which the user has stayed at the facility is added to the temporarily estimated time at which the user will stop by a normal facility after the facility and as a result, the temporarily estimated time is modified to an actual estimated time.

In this way, even when the user stops by the facility, the estimated time at which the user stops by a subsequent normal facility can be modified. By using this mode, even when there is a place whose population density significantly varies and where the user needs a significantly different length of time to pass by depending on the time of the day, such as around a ticket gate, it is possible to accurately maintain an estimated time at which the user will stop by a subsequent normal facility by instructing the movement suspension before the user passes by the place and by instructing the movement resumption after the user passes by the place.

### Example Embodiment 9

While there are cases where an accident occurs to the user or a store(s) and the user fails to receive a product(s) purchased, no measures are taken against such cases in example embodiment 1.

If the user fails to receive the product(s), the following processing is performed.

The product(s) is stored in “a checkroom for purchased products” in the facility”.

The user is notified of a password needed to receive the product(s) stored in the checkroom and in this way, the user can receive the product(s).

If the product(s) does not need to be stored or if the user does not come to receive the product(s) after a certain period of time from storage of the product(s), the product(s) is returned to the individual store(s) from the checkroom without performing payment processing.

The above description assumes that the interface with the user is mainly a visual UI of the terminal 100. However, the interface with the user is not limited to an operation on a screen and an audio UI is also applicable.

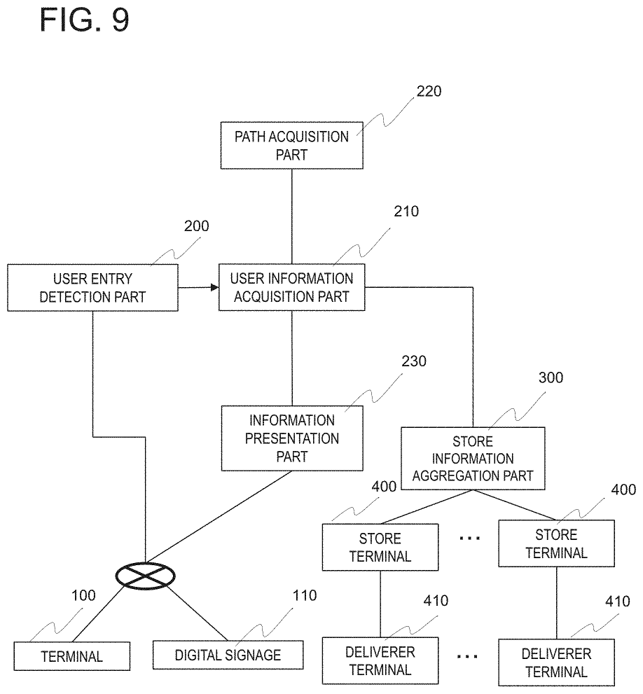

FIG. 9 is a diagram illustrating an outline of a mode including the store information aggregation part 300, the store terminals 400, the deliverer terminals 410, and the digital signage 110.

The above example embodiments may partially or entirely be described, but not limited to, as the following notes.

(Note 1) See the optimum path selection apparatus according to the above first aspect.

(Note 2) It is the optimum path selection apparatus including a receivable time determination part that determines a receivable time for an individual vendible product.

(Note 3) It is the optimum path selection apparatus including a guide part that guides a location(s) from which the purchased product(s) is to be received and guides a path(s) to the destination(s) by referring a current location(s) of the user(s) and information about the optimum path(s).

(Note 4) See the optimum path selection method according to the above second aspect.

(Note 5) It is the optimum path selection method including a receivable time determination step of determining a receivable time for an individual vendible product.

(Note 6) It is the optimum path selection method including a guide step of guiding a location(s) from which the purchased product(s) is(are) to be received and guiding a path(s) to the destination(s) by referring a current location(s) of the user(s) and information about the optimum path(s).

(Note 7) See the optimum path selection program according to the above third aspect.

(Note 8) It is the optimum path selection program causing the computer to perform a receivable time determination processing for determining a receivable time for an individual vendible product.

(Note 9) It is the optimum path selection program causing the computer to perform guide processing for guiding a location(s) from which the purchased product(s) is(are) to be received and guiding a path(s) to the destination(s) by referring a current location(s) of the user(s) and information about the optimum path(s).

Please note that the disclosure of the above PTL 1, etc. is incorporated herein by reference thereto and may be used as the basis or a part of the present invention as needed. Modifications and adjustments of the example embodiments and examples are possible within the scope of the overall disclosure (including the claims) of the present invention and based on the basic technical concept of the present invention. Various combinations and selections (including partial deletion) of various disclosed elements (including the elements in each of the claims, example embodiments, examples, drawings, etc.) are possible within the scope of the disclosure of the present invention.

Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not otherwise specified. In addition, as needed and based on the gist of the present invention, partial or entire use of the individual disclosed matters in the above literature that has been referred to in combination with what is disclosed in the present application should be deemed to be included in what is disclosed in the present application, as a part of the disclosure of the present invention.

### REFERENCE SIGNS LIST

11 CPU
12 memory
13 input-output interface
14 NIC
21 CPU
22 memory
23 input-output interface
24 transmission and reception circuit
25 camera module
26 GPS antenna
27 geomagnetic sensor
28 speaker
29 vibrator
100 terminal
110 digital signage
150 optimum path selection server
200 user entry detection part
210 user information acquisition part
220 path acquisition part
230 information presentation part
300 store information aggregation part
400 store terminal
410 deliverer terminal

What is claimed is:

1. An optimum path selection apparatus at premises, comprising:
at least a processor; and
a memory in circuit communication with the processor,
wherein the processor is configured to execute program instructions stored in the memory to implement:
a user entry detection part that receives identification information transmitted from a terminal(s) held by a user(s) and detects entry of the user(s) into predetermined premises;
a user information acquisition part that acquires, from the terminal(s), information about a destination(s) of the user(s), information about use or non-use of a facility(ies) on the premises, and information about a product(s) desired to be purchased at a store(s) on the premises;
a path acquisition part that acquires an optimum path(s) to the destination(s) via the store(s) on the premises having the product(s) in stock; and
an information presentation part that transmits the optimum path(s) to the terminal(s) held by the user(s).

2. The optimum path selection apparatus according to claim 1, wherein the processor is configured to execute the program instructions to implement:
a receivable time determination part that determines a receivable time for an individual purchasable product.

3. The optimum path selection apparatus according to claim 2, wherein the processor is configured to execute the program instructions to implement:
a guide part that guides a location(s) from which the purchased product(s) is to be received and guides a path(s) to the destination(s) by referring a current location(s) of the user(s) and information about the optimum path(s).

4. An optimum path selection method, comprising:
receiving identification information transmitted from a terminal(s) held by a user(s) and detecting entry of the user(s) into predetermined premises;
acquiring, from the terminal(s), information about a destination(s) of the user(s), information about use or non-use of a facility(ies) on the premises, and information about a product(s) desired to be purchased at a store(s) on the premises;
acquiring an optimum path(s) to the destination(s) via the store(s) on the premises having the product(s) in stock; and
transmitting the optimum path(s) to the terminal(s) held by the user(s).

5. The optimum path selection method according to claim 4, comprising determining a receivable time for an individual purchasable product.

6. The optimum path selection method according to claim 5, comprising guiding a location(s) from which the purchased product(s) is(are) to be received and guiding a path(s) to the destination(s) by referring a current location(s) of the user(s) and information about the optimum path(s).

7. A computer-readable non-transient recording medium recording an optimum path selection program, the program causing a computer to perform processings of:
receiving identification information transmitted from a terminal(s) held by a user(s) and detecting entry of the user(s) into predetermined premises;
acquiring, from the terminal(s), information about a destination(s) of the user(s), information about use or non-use of a facility(ies) on the premises, and information about a product(s) desired to be purchased at a store(s) on the premises;
acquiring an optimum path(s) to the destination(s) via the store(s) on the premises having the product(s) in stock; and
transmitting the optimum path(s) to the terminal(s) held by the user(s).

8. The medium according to claim 7, the program causing the computer to perform a receivable time determination processing for determining a receivable time for an individual purchasable product.

9. The medium according to claim 8, the program causing the computer to perform guide processing for guiding a location(s) from which the purchased product(s) is(are) to be received and guiding a path(s) to the destination(s) by referring a current location(s) of the user(s) and information about the optimum path(s).

10. The optimum path selection apparatus according to claim 1, wherein the information presentation part transmits the list of products determined to be purchased received from the user information acquisition part to the terminal(s).

11. The optimum path selection apparatus according to claim 3, wherein the terminal displays the individual estimated reception time and the store location(s) in addition to the path guide information already displayed while the terminal is performing path guide.

12. The optimum path selection apparatus according to claim 11, wherein each terminal of the individual store(s) notifies the terminal of information about completion of the preparation via the user information acquisition part when the product(s) becomes ready to be handed over to the user at each store.

13. The optimum path selection apparatus according to claim 12, wherein the terminal displays notification information indicating “prepared” on the path display.

14. The optimum path selection method according to claim 4, further comprising transmitting the list of products determined to be purchased received from the user information acquisition part to the terminal(s).

15. The optimum path selection method according to claim 6, further comprising the terminal displaying the individual estimated reception time and the store location(s) in addition to the path guide information already displayed while the terminal is performing path guide.

16. The optimum path selection method according to claim 15, further comprising each terminal of the individual store(s) notifying the terminal of information about completion of the preparation via the user information acquisition part when the product(s) becomes ready to be handed over to the user at each store.

17. The optimum path selection method according to claim 16, further comprising the terminal displaying notification information indicating “prepared” on the path display.

18. The medium according to claim 7, the program further causing a computer to perform a processing of transmitting the list of products determined to be purchased received from the user information acquisition part to the terminal(s).

19. The medium according to claim 9, the program further causing a computer to perform a processing of displaying, by the terminal, the individual estimated reception time and the store location(s) in addition to the path guide information already displayed while the terminal is performing path guide.

20. The medium according to claim 19, the program further causing a computer to perform a processing of notifying, by each terminal of the individual store(s), the terminal of information about completion of the preparation via the user information acquisition part when the product(s) becomes ready to be handed over to the user at each store.
